(19) United States
(12) Patent Application Publication
(10) Pub. No.: US 2015/0046703 A1
(43) Pub. Date: Feb. 12, 2015

(54) TARGET DIRECTED JOINING ALGORITHM FOR MULTI-PAN NETWORKS

(71) Applicant: Texas Instruments Incorporated, Dallas, TX (US)

(72) Inventors: ROBERT LIANG, FRISCO, TX (US); KUMARAN VIJAYASANKAR, DALLAS, TX (US)

(21) Appl. No.: 14/341,334

(22) Filed: Jul. 25, 2014

Related U.S. Application Data
(60) Provisional application No. 61/862,795, filed on Aug. 6, 2013.

(51) Int. Cl. H04W 12/08; H04L 9/08; H04W 4/00

(52) U.S. Cl. CPC H04W 12/08; H04W 4/008; H04L 9/0816
USPC 713/162

(57) ABSTRACT

A method of network joining. A first service node (SN) of SNs in a multi-Personal Area Network including data concentrators (DCs) that communicate with a server over a common communications medium configures a beacon request frame (BRF) including a Media Access Control (MAC) header including a header information element (HIE) or a payload IE (PIE), and a MAC CRC footer. The BRF includes a unique address of a first DC corresponding to the first SN or an encrypted data sequence with a key. The first SN transmits the BRF over the common communications medium. Responsive to receiving the BRF, the first DC processes the BRF to identify the unique address or has the key and applies the key to decipher the encrypted BRF. The first DC transmits a beacon frame over the common communications medium, wherein others of the plurality of DCs do not transmit respective beacon frames.

### CROSS REFERENCE TO RELATED APPLICATIONS

This application and the subject matter disclosed herein claims the benefit of Provisional Application Ser. No. 61/862,795 entitled “Enhanced Joining Algorithm for Multi-PAN Networks” filed Aug. 6, 2013, which is herein incorporated by reference in its entirety.

### FIELD

Disclosed embodiments relate generally to the field of communications, and more specifically to joining processes in multi-personal area networks (multi-PANs).

### BACKGROUND

Electric and gas utilities for Advanced Metering Infrastructure (AMI) and Home Area Networks (HANs) can use either wireless (RF) networks, or Powerline Communications (PLC) networks. In a typical use scenario of HANs, a plurality of home appliances acting as service nodes (SNs) each having their own local (or primary) metering are all connected to a smart meter (or utility gateway), where the SMs retrieve or exchange data with the smart meter which acts as a data concentrator (DC) or base node (BN) in the network. The DC securely aggregates data from a plurality of SNs in a residence of a utility customer and sends it to the utility server associated with a utility company.

In a typical high-density residential complex, such as apartment buildings, co-ops, or condominiums, there can be 100s of residence “homes” in a single building. This results in a large number of PANs including a large number of SNs and a plurality of smart meters/DCs (e.g., one for each home) needed to simultaneously co-exist over the same (common) communications medium in the same physical space (e.g., a large building, such as a condominium, or apartment building).

A challenge in a Multi-PAN network is for a SN device to connect to the corresponding smart meter/DC because a HAN in a home must be able to connect only to the DC for that home (generally within that home) to ensure the HAN does not join any other DC as it can lead to security concerns. Typical ways in which such a use case is ensured is by using a unique pre-shared key (PSK) and PAN Id pair. The PAN Id is chosen by the smart meter/DC and the SNs must join to the DC.

A network formation process commonly used in PLC and wireless networks involves the use of a discovery and attach process where a HAN in a home must be able to connect only to the smart meter/DC for that home. The discovery process includes the exchange of a broadcast beacon request frame from a SN device and beacons from the DCs to discover the different PAN networks operating in the vicinity of the home. The beacons from the smart meters/DCs in response to receiving the beacon request frame carry the PAN Id of the network.

A SN device after selecting a network attempts to join the network, such as using Lowpan bootstrapping protocol. The SN device and the DC validate each other based on the pre-configured Pre Shared Key (PSK). The Pan Id and PSK pair helps make a SN device uniquely attach to a network. If there is a PSK mismatch, then the joining process will fail due to an authentication failure. Although the SN may perform a discovery and successfully identify the expected PAN ID and then join the network if available, responsive to a SN device transmitting a broadcast frame beacon request, the SN can receive multiple (e.g., tens, potentially 100s of beacons) in response from the respective smart meters/DCs.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed embodiments recognize conventional joining procedures for connecting service nodes (SNs) to their corresponding smart meter containing node acting as a data concentrator (DC, base node, or utility gateway) in multi-personal area networks (multi-PANs) involve large joining process control overhead by requiring the plurality of DCs to respond to all broadcast beacon request frame (BRF) received from any SN. Conventional joining procedures are thus recognized to not be well suited for multi-PAN networks, such as for Advanced Metering Infrastructure (AMI) and Home Area Networks (HANs).

Disclosed joining algorithms are instead target directed by including in a first embodiment a unique address of a first of the plurality of DCs (first DC) or in a second embodiment at least partial encryption of a data sequence (encrypted data sequence) with a key. Accordingly, only the first DC responds to the BRF with a beacon frame, which has been found to result in significantly reduced process control overhead compared to known joining algorithms that utilize SNs transmitting conventional broadcast BRFs.

In the first embodiment the network user (homeowner) can check the Extended Unique Identifier (EUI) other unique address information for their corresponding DC and configure the SN device to transmit the BRF with the unique address so that only that DC responds with a beacon frame. A database having EUIs or other unique DC identifying information is generally maintained by the utility that may be checked from a system management perspective by the homeowner (or their agent) at the time of installation.

A method of target directed joining for multi-PAN networks includes a first SN of a plurality of SNs each having primary metering in a multi-PAN including a plurality of DCs that communicate with at least one utility server over a common communications medium configuring a BRF. The BRF comprises a Media Access Control (MAC) header including a header information element (HIE) or a payload IE (PIE), and a MAC cyclic redundancy check (CRC) footer, including a unique address of the first DC or an encrypted data sequence. The first SN transmits the BRF over the common communications medium. Responsive to the BRF, only the first DC transmits a beacon frame over the common communications medium, wherein the others of the plurality of DCs no not send the beacon frame.

### BRIEF DESCRIPTION OF THE DRAWINGS

Reference will now be made to the accompanying drawings, which are not necessarily drawn to scale, wherein:

FIG. 1 is a flowchart for an example method for target directed joining for multi-PAN networks, according to an example embodiment.

FIG. 2A is an example BRF showing its format where the address of the DC can be carried by the IEs including HIEs or PIEs, according to an example of the first embodiment.

FIG. 2B shown an example International Telecommunications Union (ITU)-G3 compliant BRF format that can carried as ciphered data in the payload, according to an example of the second embodiment.

FIG. 2C shows an example flow for a SN communicating with a DC in a multi-PAN system in a PLC-based network utilizing a BRF having ciphered text, according to an example of the second embodiment.

FIG. 3 is a block diagram schematic of a communication device for a SN having a disclosed modem that implements disclosed target directed joining for communicating in a multi-PAN network, according to an example embodiment.

FIG. 4 depicts an example multi-PAN system implementing target directed joining for multi-PAN networks in a building having 8 apartment homes and 8 HAN pairs, according to an example embodiment.

### DETAILED DESCRIPTION

Disclosed embodiments now will be described more fully hereinafter with reference to the accompanying drawings. Such embodiments may, however, be embodied in many different forms and should not be construed as limited to the embodiments set forth herein. Rather, these embodiments are provided so that this disclosure will be thorough and complete, and will fully convey the scope of this disclosure to those having ordinary skill in the art.

One having ordinary skill in the art may be able to use the various disclosed embodiments and there equivalents. As used herein, the term “couple” or “couples” is intended to mean either an indirect or direct electrical connection, unless qualified as in “communicably coupled” which includes wireless connections. Thus, if a first device couples to a second device, that connection may be through a direct electrical connection, or through an indirect electrical connection via other devices and connections.

Disclosed embodiments provide solutions to a Multi-PAN network for SN devices to connect (join) to their corresponding smart meter or DC. Disclosed embodiments generally apply any Multi-PAN network including both wireless and wired mediums such as PLC networks.

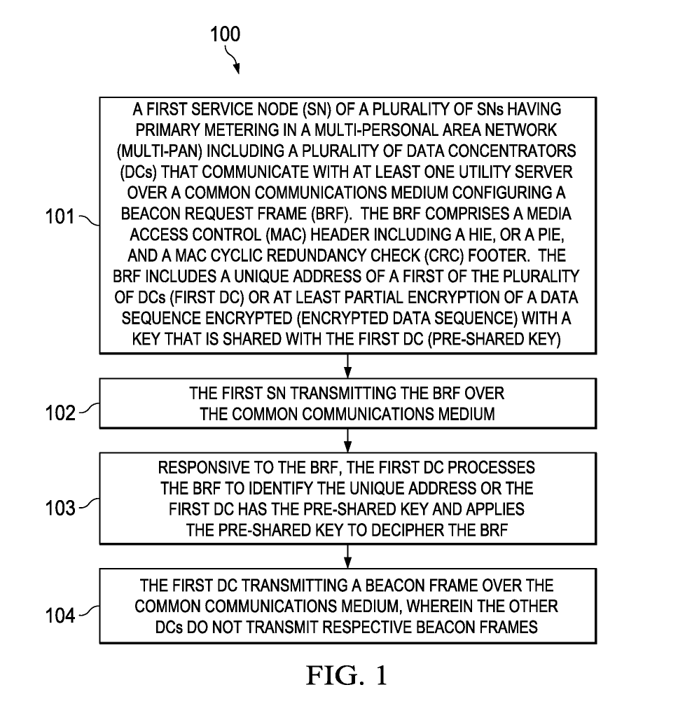

FIG. 1 is a flowchart for an example method 100 for target directed joining for multi-PAN networks, according to an example embodiment. Step 101 comprises a first SN of a plurality of SNs having primary metering in a multi-PAN that includes a plurality DCs that communicate with at least one utility server over a common medium configuring a BRF. The BRF comprises a Media Access Control (MAC) header including a HIE, or a PIE, and a MAC cyclic redundancy check (CRC) footer. The BRF includes in the first embodiment a unique address of a first of the plurality of DCs (first DC) or in the second embodiment at least partial encryption of a data sequence (encrypted data sequence) with a key that is shared with the first DC (pre-shared key).

Step 102 comprises the first SN transmitting the BRF over the common communications medium. In step 103, responsive to receiving the BRF, the first DC processes the BRF to identify the unique address (in the first embodiment) or the first DC has the pre-shared key and applies the pre-shared key to decipher the BRF (in the second embodiment). Step 104 comprises the first DC transmitting a beacon frame over the common communications medium, wherein the other DCs do not transmit respective beacon frames.

The SNs each include primary utility meters, such as gas meters, electric meters or water meters. The SNs in each home are each associated with “smart” home appliances, such a smart dishwasher, smart washer/dryer, smart refrigerator, smart electric car, smart water heater, smart oven, smart thermostat, and smart air conditioning (AC) and/or heating unit in each home, with typically four (4) or more smart home appliances in each home. The SNs include communications hardware including a modem, processor and transmitter (or transceiver) for communicating over the powerline for PLC or over air for wireless communications to their corresponding DC. The primary meter at the SN can measure electric, gas (e.g., natural gas or propane) usage, or water usage, and can include the current rate at which the electricity, gas or water is being billed.

The primary utility meters in the case of gas meters can measure the volumetric flow rate (generally in cubic feet per minute (cfm) or in m³/hr) expressed as uncorrected gas volume data (UGVD) of a combustible gas such as natural gas (or other gas such methane or propane) typically over a time interval (typically 15 minutes) being used. Most gas meters whether electronic or mechanical provide a pulsed output having a pulse count that corresponds to a particular “uncorrected gas volume”.

DCs generally comprise smart meters that act as a utility gateway to the utility network which are known to record consumption of electric energy (electricity or corrected gas volume) or water usage in intervals such as an hour or less from a plurality of their associated SNs. Each home can have its own DC acting as their smart meter. The DC smart meter has a PLC or wireless analog front end and a processor, as well as gas, electricity or water measuring circuits. In the case of gas, the DC generally performs temperature and pressure correction to generate corrected gas volume data from the uncorrected gas volume data received and state variable data (typically temperature and pressure) received from the primary gas meters at the SNs. The DC communicates the SN usage information generally at least daily back to the utility server for monitoring and billing purposes. DCs enable two-way communication with the central utility system. Unlike SNs, DCs can gather data for remote reporting to utility servers.

As noted above, in the first embodiment disclosed BRFs have a unique address for identifying a specific DC and are thus DC targeted frames, not conventional broadcast frames. A conventional HAN involves the SNs directly connected to the DC. However, since such networks are based on standard solutions, where the SNs send out conventional broadcast BRFs, all DC nodes in their vicinity that receive the broadcast BRF respond to with the transmission of a beacon according to the network standard utilized. This is recognized to result in an increased number of beacons from the DCs, which can also cause collisions.

To reduce the chances of collisions and reduce the number of beacons from the DCs responsive to BRFs, the SNs in disclosed embodiments do not transmit conventional broadcast BRFs for joining when used in such a communications network. Instead, in the first embodiment disclosed embodiments recognize given that the SNs in a HAN is needed to join only a particular PAN, so that the SN device instead transmits the BRF addressed only to the expected DC. Disclosed BRFs include a DC destination field which uniquely identifies or is uniquely receivable by a first of the plurality of DCs (first DC), where responsive to the BRF, the first DC transmits a beacon frame over the common medium, while others of the plurality of DCs despite receiving the BRF do not respond with a beacon frame.

The SN transmitting the BRF addressed only to the corresponding DC (e.g., in their home) can be achieved in one embodiment by the SN transmitting the BRF using a unicast address instead of a broadcast address in a MAC Header. A unicast address is an address that identifies a unique node on a network. The unicast address can be the EUI address of the DC which is unique per DC device. The network user can generally check the EUI of the expected/corresponding smart meter/DC (from a database maintained by the utility) and configure the SN device to transmit the BRF to only that DC.

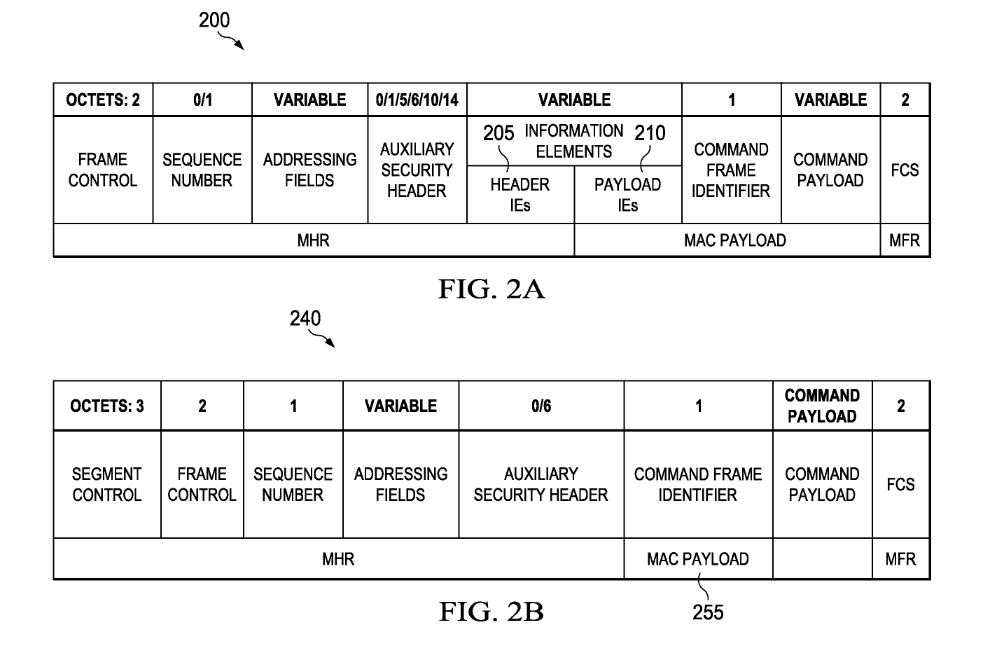

A variant of the first embodiment achieves the same result by being still compliant with the standard utilized (e.g., IEEE P1901.2) which can be provided using an Information Element (IE) for the unique address in the BRF format. FIG. 2A shows an example BRF 200 which can be used in PLC standards such as IEEE P1901.2. MHR stands for MAC header and MFR for the MAC footer. The MFR includes a MAC cyclic redundancy check (CRC). The HIEs 205 or a PIEs 210 can be used to carry the EUI address of the corresponding DC. Only the particular DC that sees its EUI address in the IE of the BRF 200 will transmit a beacon frame responsive to the BRF 200.

In the second embodiment, the BRF includes encryption at least in part, such as an encrypted payload. Although the above-described embodiments using BRF 200 or similar frames ensure that only one DC transmits a beacon responsive to a BRF from a SN, such embodiments still need each SN device to be configured manually with the unique address of the target DC. As the unique address in the BRF is sent out unencrypted, this is recognized to have the potential to cause security concerns.

The second embodiment achieves the objective of having only the corresponding DC to transmit the beacon responsive to a BRF from a SN without the need for a pre-configuration of the unique DC address (e.g., EUI address) in the BRF. This embodiment can encrypt a known standard data sequence (e.g., “PAN ID selection”) using a Pre Shared Key (PSK) into ciphered data, or the entire BRF can be encrypted. In this embodiment the BRF may still be a broadcast frame at MAC layer so that all DCs in the multi-PAN can still receive and process the BRF. However, only the DC having the pre-known information stored in its memory can decipher or understand that the BRF is actually intended for it, and will respond with a beacon frame.

The operation of a cipher as known in encryption depends auxiliary information, commonly referred to as a “key”. The encrypting procedure is varied depending on the key, which changes the detailed operation of the encrypting algorithm. A key is generally selected before using a cipher to encrypt a message. Without knowledge of the key, it is generally impossible to decrypt the resulting ciphertext into readable plaintext.

This ciphered data can be transmitted in the BRF either as a HIE or a PIE as shown in FIG. 2A, or as a beacon payload as shown MAC payload 255 within the BRF 240 in FIG. 2B. Only the particular DC which has the same pre-configured PSK will be able to decipher the ciphered sequence. Accordingly, only that particular DC can respond with a BRF. The algorithm is also backward compatible with existing standards as nodes that do not follow this method will simply drop this frame as they cannot decipher it. BRF 240 is an International Telecommunications Union (ITU)-G3 compliant BRF format.

FIG. 2C shows an example flow 270 for a SN 280 communicating with a DC 290 in a multi-PAN system in a PLC-based network utilizing a BRF having ciphered text, according to an example of the second embodiment. A known data sequence 281 is encrypted with PSK in step 282 to generate ciphered text 283, where the ciphered text is inserted into the BRF in step 284, which is transmitted over the PLC line 295, such as using Orthogonal Frequency Division Multiplex (OFDM). The DC 290 extracts the ciphered frame from the BRF in step 291, and in step 292 decrypts the ciphered data. The DC then in decision step 293 determines if the decrypted data sequence is the known data sequence. If the decrypted data sequence is the known data sequence, the DC 290 transmits the beacon request in step 294, and if the decrypted data sequence is not the known data sequence, in step 296 the DC 290 ignores the BRF/packet.

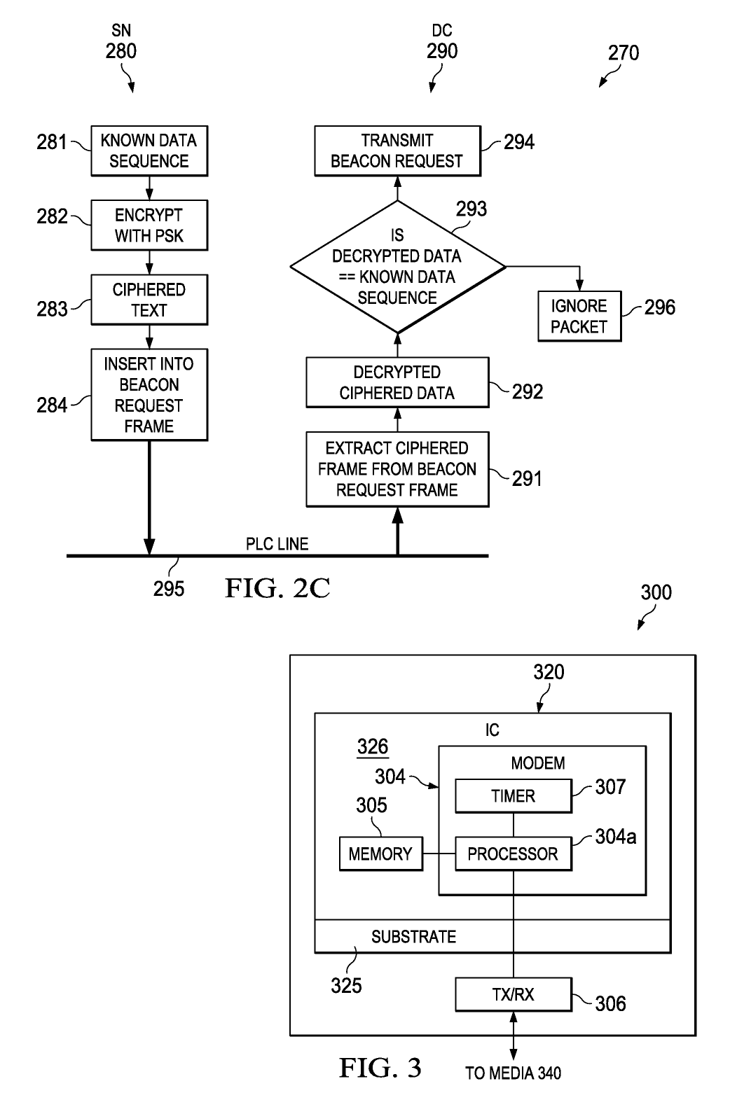

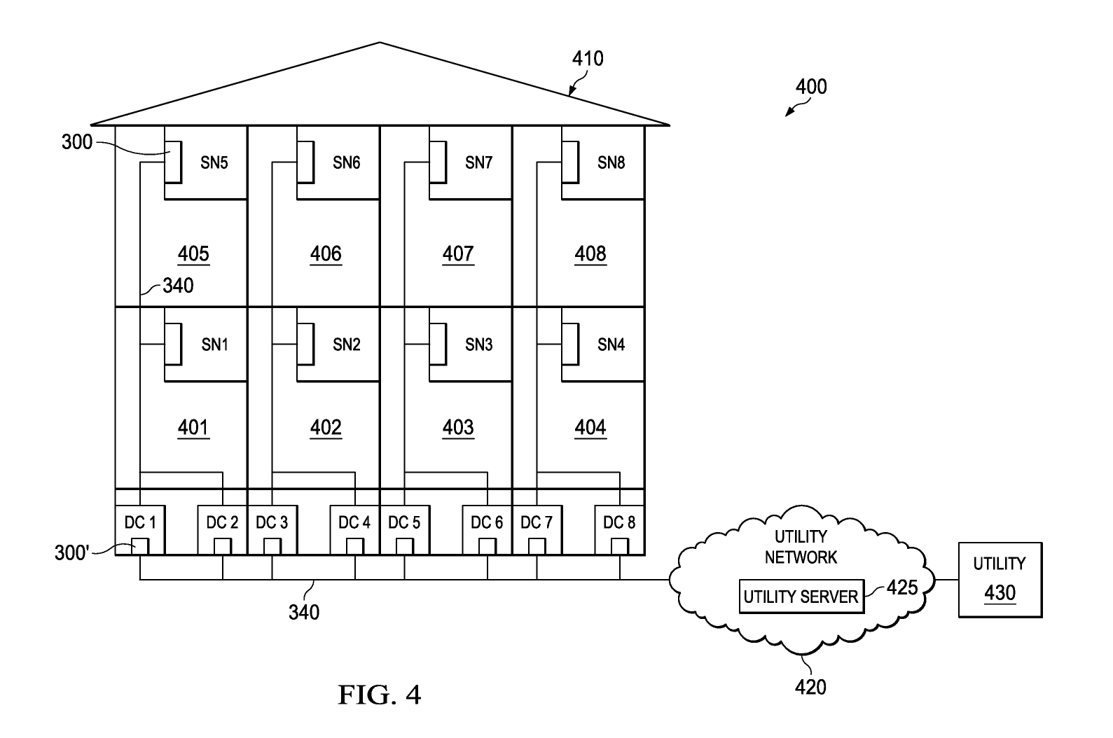

FIG. 3 is a block diagram schematic of a communication device 300 having a disclosed modem 304 that implements disclosed target directed joining using a unique address of a DC or an encrypted data sequence in the BRF for communicating in a multi-PAN network, according to an example embodiment. Communications device 300 having different programming stored in the memory 305 may also be used by DCs in the multi-PAN, shown as communications device 300′ in FIG. 4 described below.

Modem 304 includes a processor (e.g., a digital signal processor, (DSP)) 304a having associated non-transitory memory 305 that implements a disclosed joining algorithm. Modem 304 also includes at least one timer shown as timer 307. Memory 305 comprises non-transitory machine readable storage, for example, static random-access memory (SRAM).

The modem 304 is shown formed on an integrated circuit (IC) 320 comprising a substrate 325 having a semiconductor surface 326, such as a silicon surface. In another embodiment the modem 304 is implemented using 2 processor chips, such as 2 DSP chips. Communications device 300 also includes an analog from end (AFE) shown as a transceiver (TX/RX) 306 that allows coupling of the communications device 300 to the common communications media 340, such as a powerline for PLC or over the air for wireless communications, to facilitate communications with its corresponding DC. For wireless applications, transceiver 306 comprises a wireless transceiver that is coupled to an antenna (not shown). In one embodiment the transceiver 306 comprises an IC separate from IC 320. Besides the DSP noted above, the processor 304a can comprise a desktop computer, laptop computer, cellular phone, smart phone, or an application specific integrated circuit (ASIC).

Disclosed modems 304 and disclosed communications devices 300 can be used in a PLC network to provide a networked device that in service is connected to a powerline via a power cord. In general, the “networked device” can be any equipment that is capable of transmitting and/or receiving information over a powerline. Examples of different types of networked devices include, but are not limited or restricted to a computer, a router, an access point (AP), a wireless meter, a networked appliance, an adapter, or any device supporting connectivity to a wired or wireless network.

FIG. 4 depicts an example multi-PAN system 400 implementing target directed joining for multi-PAN networks in a building 410 having 8 apartment homes 401, 402, 403, 404, 405, 406, 407 and 408 and 8 HAN pairs, according to an example embodiment. The SNs in system 400 are shown for simplicity as a single SN per home as SN1, SN2, SN3, SN4, SN5, SN6, SN7 and SN8, each having a communications device 300. Each SN is associated with a utility consuming appliance, such a smart dishwasher, smart washer/dryer, smart refrigerator, smart electric car, smart water heater, smart oven, smart thermostat, and smart air conditioning (AC) and/or heating unit in each home 401-408.

The DCs in system 400 are shown as DC1, DC2, DC3, DC4, DC5, DC6, DC7 and DC8, each having a communications device 300′. The lines shown between the communications devices 300 of the SNs and the communications devices 300′ of the DCs can represent powerlines for PLC networks or air for wireless communication networks. The DCs are shown communicably coupled to a utility network 420 having a utility server 425 by communications media 340, such as a powerline for PLC communications or over the air for wireless communications. The utility network 420 is shown communicably coupled to a utility 430.

In operation of system 400, communications device 300 for say home 401 configures and transmits a BRF having a DC destination field therein over a PLC line, such as the PLC line 295 shown in FIG. 2C. Its corresponding DC, DC1, receives the BRF and responds with a beacon frame, while the other DCs (DC2-DC8) do not respond with a beacon frame as they either do not see their address in the case the BRF including a unique address or they lack the key to decipher in the case of ciphered data. For example, example flow 270 described above relative to FIG. 2C may be implemented.

Disclosed systems and methods are generally applicable to a wide variety of multi-PAN communication environments, including, but not limited to, those involving wireless communications (e.g., cellular, Wi-Fi, WiMax, etc.), wired communications (e.g., Ethernet, etc.), PLC, or the like. As a person of ordinary skill in the art will recognize in light of this disclosure, however, certain techniques and principles disclosed herein may also be applicable to other communication environments.

Many modifications and other embodiments will come to mind to one skilled in the art to which this Disclosure pertains having the benefit of the teachings presented in the foregoing descriptions, and the associated drawings. Therefore, it is to be understood that embodiments of the invention are not to be limited to the specific embodiments disclosed. Although specific terms are employed herein, they are used in a generic and descriptive sense only and not for purposes of limitation.

1. A method of network joining, comprising:
a first service node (SN) of a plurality of SNs having primary metering units in a multi-Personal Area Network (multi-PAN) including a plurality of data concentrators (DCs) that communicate with at least one server over a common communications medium configuring a beacon request frame (BRF), wherein said BRF comprises a Media Access Control (MAC) header including a header information element (HIE), or a payload IE (PIE), and a MAC cyclic redundancy check (CRC) footer, said BRF including a unique address of a first of said plurality of DCs (first DC) or at least partial encryption of a data sequence (encrypted data sequence) with a key shared with said first DC (pre-shared key);
said first SN transmitting said BRF over said common medium;
responsive to receiving said BRF, said first DC processing said BRF to identify said unique address or said first DC having said pre-shared key and applying said pre-shared key to decipher said BRF, and
said first DC transmitting a beacon frame over said common communications medium, wherein others of said plurality of DCs do not transmit respective beacon frames.

2. The method of claim 1, wherein said unique address comprises a unicast address in said MAC header.

3. The method of claim 1, wherein said unique address is included in said HIE or in said PIE.

4. The method of claim 1, wherein said encrypted data sequence comprises encryption of an entirety of said BRF.

5. The method of claim 1, wherein said encrypted data sequence is transmitted in said HIE, said PIE, or as a MAC payload.

6. The method of claim 1, wherein said plurality of SNs and said plurality of DCs are all within a common building having a plurality of homes.

7. The method of claim 1, wherein said common communications medium is a powerline supporting powerline communications (PLC).

8. The method of claim 1, wherein said common communications medium is a wireless medium supporting wireless communications.

9. A modem for a service node (SN) to communicate in a multi-Personal Area Network (multi-PAN) including a plurality of data concentrators (DCs) that communicate with at least one utility server over a common communications medium, comprising:
a processor, wherein said processor is communicably coupled to a memory which stores a target directed joining algorithm (joining algorithm) for said multi-PAN including code for compiling a beacon request frame (BRF), and wherein said processor is programmed to implement said joining algorithm, said joining algorithm:
configuring said BRF comprising a Media Access Control (MAC) header including a header information element (HIE), or a payload IE (PIE), and a MAC cyclic redundancy check (CRC) footer, said BRF including a unique address of a first of said plurality of DCs (first DC) or at least partial encryption of a data sequence (encrypted data sequence) with a key, and
causing said first SN to transmit said BRF over said common communications medium.

10. The modem of claim 9, wherein said modem is formed on an integrated circuit (IC) comprising a substrate having a semiconductor surface, wherein said processor comprises a digital signal processor (DSP).

11. The modem of claim 9, wherein said unique address comprises a unicast address in said MAC header.

12. The modem of claim 9, wherein said unique address is included in said HIE or said PIE.

13. The modem of claim 9, wherein said encrypted data sequence comprises encryption of an entirety of said BRF.

14. The modem of claim 9, wherein said encrypted data sequence is transmitted in said BRF as said HIE, said PIE, or a MAC payload.

15. A multi-Personal Area Network (PAN) system, comprising:
a plurality of data concentrators (DCs) each including a DC modem including a DC processor that is coupled to a DC memory, said DC modem coupled to a DC transceiver configured to communicate with at least one utility server over a common communications medium;
a plurality of service nodes (SN) each including a SN modem including a SN processor that is coupled to a SN memory, said SN modem coupled to a SN transceiver configured to communicate over said common communications medium, wherein said SN processor is communicably coupled to said SN memory which stores a target directed joining algorithm (joining algorithm) for said multi-PAN system including code for compiling a beacon request frame (BRF), and wherein said SN processor is programmed to implement said joining algorithm, said joining algorithm:
configuring said BRF comprising a Media Access Control (MAC) header including a header information element (HIE) or a payload IE (PIE), and a MAC cyclic redundancy check (CRC) footer, said BRF including a unique address of a first of said plurality of DCs (first DC) or at least partial encryption of a data sequence (encrypted data sequence) with a key shared with said first DC (pre-shared key), and causing said first SN to transmit said BRF over said common communications medium;
responsive to receiving said BRF, said first DC configured for processing said BRF to identify said unique address or said first DC having said pre-shared key in said DC memory and applying said pre-shared key to decipher said BRF, and
said first DC configured for transmitting a beacon frame over said common communications medium, wherein others of said plurality of DCs are configured for not transmitting respective beacon frames.

16. The system of claim 15, wherein said unique address comprises a unicast address in said MAC header or is included in said HIE, or in said PIE.

17. The system of claim 15, wherein said encrypted data sequence comprises encryption of an entirety of said BRF.

18. The system of claim 15, wherein said plurality of SNs and said plurality of DCs are all within a common building having a plurality of homes.

19. The system of claim 15, wherein said common communications medium is a powerline supporting powerline communications (PLC).

20. The system of claim 15, wherein said common communications medium is a wireless medium supporting wireless communications.
